(19) United States
(12) Patent Application Publication
(10) Pub. No.: US 2025/0135731 A1
(43) Pub. Date: May 1, 2025

(54) METHOD FOR PRODUCING A PUMP DEVICE

(71) Applicant: MAHLE International GmbH, Stuttgart (DE)

(72) Inventors: Torsten Klein, Hildburghausen (DE); Michael Langer, Bad Rodach (DE); Michael Sahr, Eisfeld (DE); Christoph Jacobi, Eisfeld (DE); Holger Conrad, Veilsdorf (DE); Dieter Hoehn, Hildburghausen (DE)

(21) Appl. No.: 18/926,303

(22) Filed: Oct. 24, 2024

(30) Foreign Application Priority Data
Oct. 25, 2023 (DE) 10 2023 210 543.8

(51) Int. Cl. B29C 65/00; B29C 65/36; B29L 31/00; H02K 15/10

(52) U.S. Cl. CPC B29C 66/7422; B29C 65/3656; B29C 66/30321; B29C 66/30325; H02K 15/10; B29L 2031/7496

(57) ABSTRACT

A method of manufacturing a pump device for conveying a fluid may include providing a metal housing and a further component. The further component may have plastic on at least one outer side. The method may further include bringing the at least one outer side of the further component into contact with a connecting section of the metal housing, heating the metal housing such that the plastic of the further component melts at the connecting section of the metal housing and wets the connecting section, and terminating the heating of the metal housing such that the plastic hardens and the further component is thermally joined to the metal housing at the connecting section.

### CROSS-REFERENCE TO RELATED APPLICATIONS

This application claims priority to German Patent Application No. DE 10 2023 210 543.8, filed Oct. 25, 2023, the contents of which is hereby incorporated by reference in its entirety.

### TECHNICAL FIELD

The present invention relates to a method of manufacturing a pump device for conveying a fluid, in particular oil. The invention also relates to a pump device manufactured in this way.

### BACKGROUND

A pump device is used to convey a fluid. The pump device has several components, for example a housing, a mechanism for pumping the fluid and a drive for driving the mechanism. To manufacture the pump device, at least some components of the pump device are mechanically connected to each other.

### SUMMARY

The present invention is concerned with the task of providing improved or at least other embodiments for a method of manufacturing a pump device of the aforementioned type and for a pump device manufactured in this way. In particular, the present invention deals with the task of specifying embodiments for the method and for the pump device which are characterized by reduced manufacturing costs and/or reduced weight and/or an improved environmental balance.

According to the invention, this task is solved by the subject matter of the independent claim(s). Advantageous embodiments are the subject matter of the dependent claim(s).

Accordingly, the present invention is based on the basic idea of providing a housing of a pump device as a metal housing and forming at least one further component of the pump device, which is to be connected to the metal housing, with plastic on at least one outer side, wherein, in order to connect the component to the metal housing, the plastic is brought into contact with the metal housing and melted by means of heat supply, so that a thermal joint is formed between the metal housing and the component during the final hardening of the plastic. In this way, in addition to a simple mechanical connection of the component to the metal housing, there is no need for separate connecting components, such as screws, an adhesive, and the like. As a result, the pump device is both cost-effective and lightweight. In addition, the elimination or at least reduced use of such connecting components, in particular adhesives, leads to a more environmentally-friendly production and design of the pump device.

In accordance with the idea of the invention, the metal housing and the component are provided for manufacturing the pump device. The component has plastic on at least one outer side. To connect the component to the metal housing, the outer side is brought into contact with a section of the metal housing, which is also referred to below as the connecting section. By heating the metal housing, in particular inductively, the plastic of the component is melted at the connecting section and wets the connecting section. The heating is then stopped so that the plastic hardens and the component is thermally joined to the metal housing at the connecting section. The component is therefore connected to the metal housing at the connecting section by means of a thermal joint.

In the present case, “metal housing” means a housing made of a metal or alloy. Preferably, at least the connecting section consists of the metal or alloy.

In principle, the component can only have plastic on the outer side. This means that the component can only be made of plastic on the outer side.

For example, the component can be coated with the plastic. In particular, the component can be encapsulated with the plastic. In this way, the component is not made entirely of plastic. This makes it possible to use a large number of components to produce a thermal joint of the type described.

Preferably, the component has plastic on its entire outer surface. This means that at least the entire outer surface of the component is made of plastic. This results in a simplified and flexible production of the pump device and a mechanically stable thermal connection between the metal housing and the component.

Advantageously, the component and the metal housing are subjected to mechanical stresses against each other, at least when the plastic is melted. This allows the metal housing to penetrate the melted plastic. This leads to increased mechanical stability and load-bearing capacity of the thermal joint.

The pump device is used to convey a fluid. This means that the pump device conveys, in particular pumps, a fluid during operation. For this purpose, the pump device has an appropriately designed mechanism such that the mechanism conveys the fluid during the drive. The mechanism can be, for example, a conveyor wheel, a gear wheel, a gerotor, and the like.

The drive is preferably electric. For this purpose, the drive advantageously has a stator assembly with a stator which, during operation, interacts with a rotor connected to the mechanism in terms of drive.

The pump device can be used to convey any fluids.

For example, the fluid is a liquid, in particular oil. The pump device can therefore be an oil pump, in particular.

The pump device can be used in any application.

The pump device is used, for example, in a motor vehicle to convey a fluid, in particular oil, within the vehicle.

In preferred embodiments, the connecting section has elevations pointing towards the component and depressions pointing away from the component. This means that a metal housing is provided with a connecting section with such elevations and depressions. The elevations and depressions can be created by roughening the connecting section. As a result, the melted plastic penetrates into the depressions. This hardens the plastic in the depressions. The result is a mechanically more stable and resilient connection between the component and the metal housing. The molten plastic advantageously fills the depressions and then hardens in them. This results in a particularly stable mechanical connection between the component and the metal housing. Preferably, the elevations penetrate the melted plastic at the same time and remain in the subsequently hardened plastic. This in turn leads to improved mechanical stability and load-bearing capacity of the joint.

In principle, the connecting section can be provided at any position on the metal housing. This means that the component can be connected to the metal housing at any point.

In preferred embodiments, the connecting section is arranged on an end face of the metal housing. This means that the outer side of the component is brought into contact with an end face of the metal housing as the connecting section. In particular, the end face can correspond to the connecting section.

Advantageously, the component is the stator assembly of the pump device.

Preferably, the stator of the stator assembly is encapsulated with plastic so that the plastic forms the outer side of the stator assembly. The stator assembly therefore comprises the stator and the plastic, which encloses the stator in the form of an outer casing.

Preferably, the connecting section is formed on the end face of the metal housing; in particular, the end face corresponds to the connecting section. The connecting section is advantageously inclined or runs transversely to the longitudinal center axis of the stator assembly, i.e., in particular also to an axis of rotation of the drive. In this way, the stator assembly is also mechanically stable against twisting around the axis of rotation or longitudinal center axis on the metal housing. Preferably, the elevations and depressions are parallel or inclined to the longitudinal center axis or the axis of rotation.

In principle, the component can also be mechanically connected to the metal housing in other ways in addition to the thermal joint.

Advantageously, the component is connected to the metal housing exclusively by means of the thermal joint.

It is conceivable to actively cool the metal housing and/or the component after heating is complete. This results in a faster hardening of the plastic, which in particular leads to an increased cycle time in the production of the pump device.

It is clear that the pump device can also have two or more such components, each of which is/are connected to the metal housing as described.

It is to be understood that, in addition to the method for manufacturing the pump device, a pump device manufactured in this way as such also forms part of the scope of the present invention.

Further important features and advantages of the invention are apparent from the sub-claims, from the drawings and from the associated description of the figures with reference to the drawings.

It is understood that the above-mentioned features and those yet to be explained below can be used not only in the combination indicated in each case, but also in other combinations or on their own, without deviating from the scope of the present invention.

Preferred exemplary embodiments of the invention are shown in the drawings by way of example and will be explained in more detail in the following description, wherein identical reference signs refer to identical or similar or functionally identical elements.

### BRIEF DESCRIPTION OF THE DRAWINGS

The following is shown in the images, in each case systematically:

FIG. 1 shows an isometric view of a pump device with a metal housing and a component,

FIG. 2 shows an isometric view of the component,

FIG. 3 shows an isometric view of a stator of the component,

FIG. 4 through FIG. 6 show, in each case, a simplified sectional view of successive measures for manufacturing the pump device.

### DETAILED DESCRIPTION

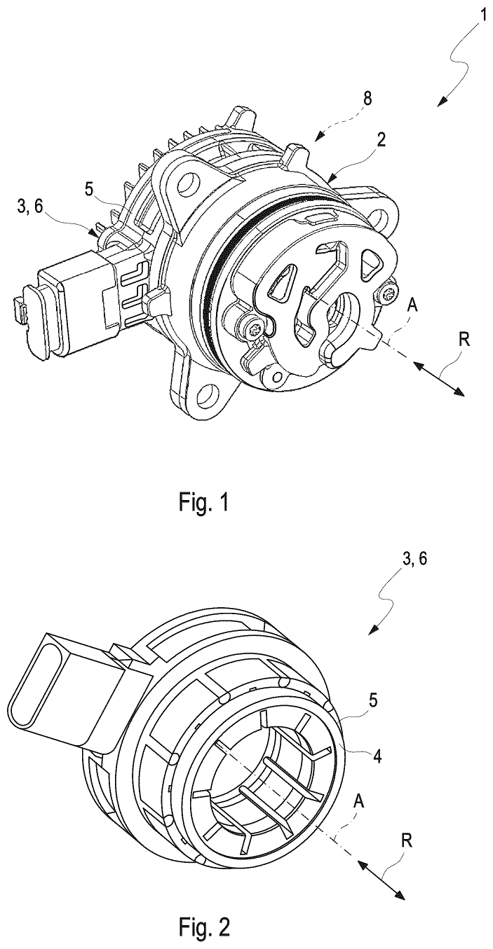

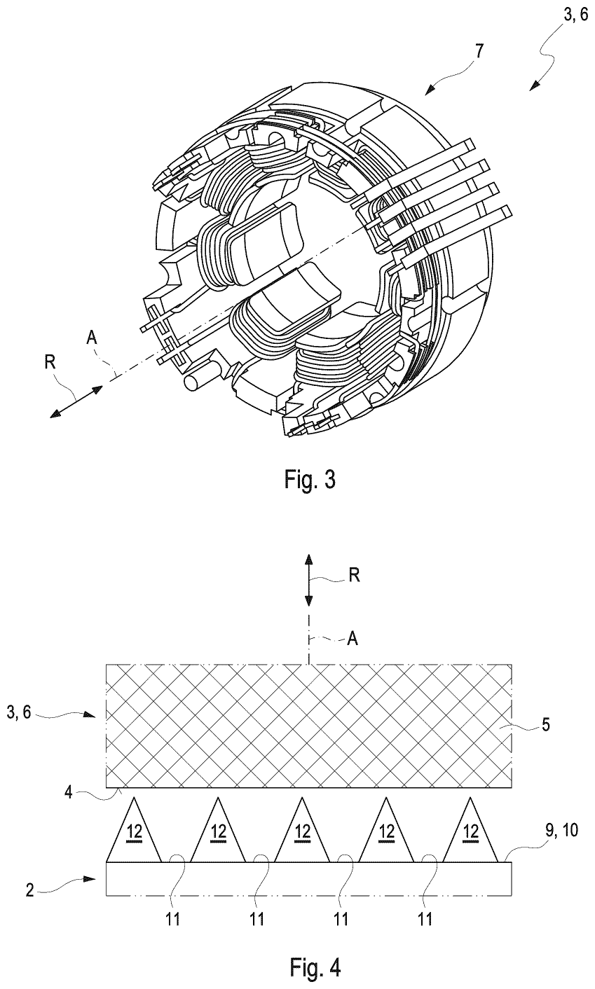

A pump device 1, as shown as an example in FIG. 1, has a metal housing 2, for example made of aluminum. The pump device 1 also has a component 3, which has plastic 5 on at least one outer side 4. In the exemplary embodiments shown, the component 4 is a stator assembly 6 of the pump device 1, which is shown separately in FIG. 2. The stator assembly 6 has a stator 7, shown separately in FIG. 3, as a component of a drive 8 of the pump device 1, which is not shown. During operation, the drive 8 drives a mechanism, not shown, for conveying a fluid, for example oil. As can be seen from a combined view of FIGS. 2 and 3, the stator 8 in the stator assembly 6 is coated with plastic 5 in the exemplary embodiments shown, and encapsulated in the exemplary embodiments shown. Thus, in the exemplary embodiments shown, the entire outer surface of the stator assembly 6 consists essentially of the plastic 5.

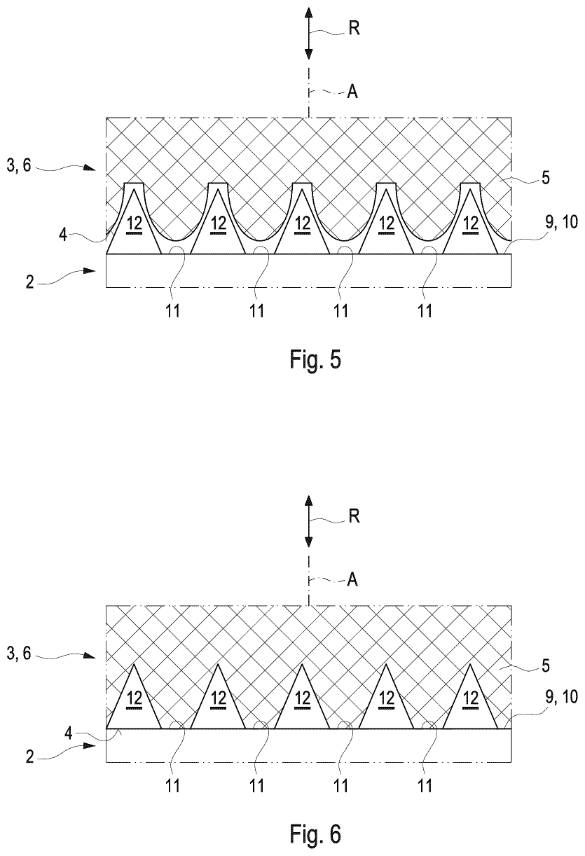

To manufacture the pump device 1, as indicated in FIGS. 4 through 6, the outer side 4 of the component 3 is brought into contact with a section 9 of the metal housing 2 (see FIG. 4), wherein the section 9 is hereinafter also referred to as the connecting section 9. In the exemplary embodiments shown, the connecting section 9 is arranged on an end face 10 of the metal housing 2, which faces the stator assembly 6 in the pump device 1. Then, as indicated in FIG. 5, the metal housing 2 is heated by means of a heat supply so that the plastic 5 of the component 3 melts at the connecting section 9 and wets the connecting section 9. When the heating is subsequently completed, the plastic 5 hardens, as indicated in FIG. 6, so that the component 3 is thermally joined to the metal housing 2 at the connecting section 9. This means that the component 3 is connected to the metal housing 2 by means of a thermal joint. The component 3 and/or the metal housing 2 can be actively cooled to accelerate the hardening of the plastic 5. The component 3 can therefore be connected to the metal housing 2 without any other components, in particular without screws or adhesive. This leads to a simple, cost-effective, weight-reduced, and environmentally-friendly production of the pump device 1. In the exemplary embodiments shown, the component 3 is connected to the metal housing 2 exclusively by means of thermal joining.

As can be seen in FIGS. 4 through 6, the metal housing 2 and the component 3 are subjected to mechanical stresses during manufacture, in particular during the melting process of the plastic 5.

In the exemplary embodiments shown, as can be seen in FIGS. 4 through 6, the connecting section 9 has elevations 12 and depressions 11. The elevations 12 are directed towards component 3 and the depressions are directed away from component 3. The elevations 12 and depressions 11 can be introduced into the connecting section 9 by roughening the connecting section 9 before the connecting section 9 is brought into contact with the outer side 4. As a comparison of FIGS. 5 and 6 shows, the molten plastic penetrates into the depressions 11. In the exemplary embodiments shown, the melted plastic fills the depressions 11, as can be seen in particular in FIG. 6. At the same time, the elevations 12 penetrate the melted plastic 5. The plastic 5 and thus the outer side 4 and the metal housing 2 thus penetrate each other, so that the mechanical connection is stabilized.

As indicated in FIGS. 4 through 6, the depressions 11 and the elevations 10 in the exemplary embodiments shown are directed parallel or inclined, in the exemplary embodiments shown parallel, to a longitudinal center axis A of the stator assembly 6. In the exemplary embodiments shown, the longitudinal center axis A runs parallel, in particular coaxially, to an axis of rotation R of the drive 8. This results in a special stabilization of the connection of the stator assembly 6 on the metal housing 2 against rotations of the drive 8 around the axis of rotation R.

1. A method of manufacturing a pump device for conveying a fluid, comprising:
providing a metal housing;
providing a further component that has plastic on at least one outer side;
bringing the at least one outer side of the further component into contact with a connecting section of the metal housing;
heating the metal housing such that the plastic of the further component melts at the connecting section of the metal housing and wets the connecting section;
terminating the heating of the metal housing such that the plastic hardens and the further component is thermally joined to the metal housing at the connecting section.

2. The method according to claim 1, wherein the connecting section of the metal housing includes a plurality of depressions directed away from the further component and into which the molten plastic penetrates.

3. The method according to claim 1, wherein the further component is coated with the plastic.

4. The method according to claim 1, wherein an end face of the metal housing defines the connecting section of the metal housing.

5. The method according to claim 1, wherein the further component is a stator assembly of a drive of the pump device.

6. The method according to claim 5, wherein a stator of the stator assembly is encapsulated with the plastic such that the plastic forms the at least one outer side of the stator assembly.

7. The method according to claim 6, wherein:
an end face of the metal housing defines the connecting section of the metal housing; and
the connecting section of the metal housing includes a plurality of depressions directed one of parallel and transversely to a longitudinal center axis of the stator assembly.

8. The method according to claim 1, wherein the further component is connected to the metal housing exclusively via the thermal joining.

9. The method according to claim 1, further comprising actively cooling at least one of the metal housing and the further component to harden the plastic.

10. A pump device for conveying a fluid, comprising a metal housing and a further component that is thermally joined to a connecting section of the metal housing via plastic disposed on at least one outer side of the further component, wherein the pump device is manufactured in accordance with the method according to claim 1.

11. The method according to claim 1, wherein the further component is completely encapsulated in the plastic.

12. The method according to claim 1, wherein:
the connecting section of the metal housing includes a plurality of elevations directed toward the further component; and
heating the metal housing such that the plastic wets the connecting section includes covering the plurality of elevations with the molten plastic.

13. The method according to claim 12, wherein:
the connecting section of the metal housing includes a plurality of depressions directed away from the further component; and
heating the metal housing such that the plastic wets the connecting section further includes filling the plurality of depressions with the molten plastic.

14. The method according to claim 1, further comprising subjecting the metal housing and the further component to mechanical stresses against one another.

15. The method according to claim 14, wherein the metal housing and the further component are subjected to the mechanical stresses when the plastic is melted.

16. The method according to claim 1, wherein the metal housing is heated inductively.

17. The method according to claim 5, wherein the stator assembly is completely encapsulated with the plastic such that an entire outer surface of the stator assembly is formed by the plastic.

18. The method according to claim 5, wherein the connecting section of the metal housing includes a plurality of depressions directed parallel to a longitudinal center axis of the stator assembly.

19. The method according to claim 5, wherein the connecting section of the metal housing includes a plurality of depressions directed transversely to a longitudinal center axis of the stator assembly.

20. The method according to claim 5, wherein:
an end face of the metal housing defines the connecting section of the metal housing; and
the end face of the metal housing extends transversely to a longitudinal center axis of the stator assembly.
